(19) United States
(12) Patent Application Publication
(10) Pub. No.: US 2023/0177123 A1
(43) Pub. Date: Jun. 8, 2023

(54) SYSTEM AND METHOD FOR VERIFYING, AUTHENTICATING AND TAGGING OF CONTENT CREATORS

(71) Applicant: Sprig Technologies Ltd., Dublin (IE)

(72) Inventors: John Michael Killian, Longford (IE); Christopher Anthony McCauley, Dublin (IE)

(21) Appl. No.: 17/545,175

(22) Filed: Dec. 8, 2021

(51) Int. Cl. G06F 21/10; G06Q 50/18; G06Q 30/06; G06Q 30/02

(52) U.S. Cl. CPC G06F 21/10; G06Q 50/184; G06Q 30/0633; G06Q 30/0201

(57) ABSTRACT

A system includes a processor and a Graphical User Interface (GUI) in communication with the processor. The processor is configured to operably render the GUI for displaying one or more user-selectable options for requesting a user of the GUI to input data pertaining to Intellectual Property (IP) and pre-defined user criteria, fetching product listings related to the IP and satisfying the pre-defined user criteria input by the user, tagging of one or more content creators related to the product listings, grouping these content creators based on various behavioral patterns and attributes associated with each of the content creators, verifying and authenticating if these content creators are in violation of the IP, mapping each of the content creators into respective ones of a plurality benchmarks based on the verification and authentication, and setting a periodical authentication at a pre-determined frequency based on the map.

### TECHNICAL FIELD

The present disclosure relates to verification, authentication and tagging methods for anonymous online content creators, and more specifically to intellectual property rights protection and anti-counterfeit technology against such online content creators.

### BACKGROUND

Intellectual Property (IP) owners encounter a very high volume of online listings and content across a wide range of channels, for example, web domains, social media etc. These IP owners may include, but are not limited to, trademark holders, copyright owners and/or patent holders that are being represented by one or more brands of physical consumer goods, for example, footwear, jewelry, electronics, toys or any other type of physical products that can be sold online.

These online product listings, or content, may be created by a range of third parties, including, but not limited to, private individuals, sole traders, small and large businesses, small and large retailers, and small and large online webstore operators. Currently, there are many online/ecommerce sales channels where many millions of these third parties can create product listings, or content, related to the products of the IP/Brand owners. A high number of potential channels when combined with a high number of third parties, or a high number of products from each third party, can result in a very high number, for example—billions, of product listings, or content, related to the IP/Brand owners to appear online. With at least thousands of channels, millions of third party content creators, and the resulting billions of product listings, or content, it is virtually impossible for the IP/Brand owners to track, or simply know, exactly where their IP/Brand is being listed, by whom and if such product listing, or content, has been made under authorization and approval of the IP/Brand owner.

In some cases, these product listings may be in violation of, or unauthorized for use by, specific acts or rules as dictated by the laws pertaining to jurisdictions in which the IP/Brand owner has IP, or other equivalent control measures, in place for listing or content, for example, an advertisement pertaining to a sale of the product. In fact, these product listings may not be even genuine in that they may be for fake/counterfeit products, or are misleading in the one or more following ways, including, but not limited to, a) Parallel imports not intended for sale within certain jurisdictions, for example, in the European Economic Area (EEA), b) potential risk of counterfeit or pirated products being sold in the jurisdiction, c) products obtained by theft, pilferage or other fraudulent means, or d) products materially different to those sold by authorized sellers or resellers.

Because of the extremely high volumes of product listings, or content, resulting from a high number of online channels, actual product types, and third parties or content creators, a very high percentage of these third parties, or content creators, are, or remain, anonymous to the IP owner. With use of current methods known in the art, IP/Brand owners may, upon gaining knowledge of one or more content creators in violation of rights of the IP/Brand owners, be required to essentially make ‘judgement calls’ on the content creators that they discover online. Some of these judgement calls may include, a decision based on whether these third parties, or content creators, are being legitimate in presenting the product listing to customers and/or if these third parties, or content creators, are in violation of one or more rights that are assigned, by law, to the IP/Brand owner. The term ‘content creators’ used herein is to be considered as being inclusive of a range of third parties, but is not limited to, private individuals, sole traders, small and large businesses, small and large retailers, small and large online webstore operators that are typically known to create ‘product listings’ for selling one or more products to consumers via various online channels. When creating these product listings, these content creators may make use of, or reference, for example, the trademarks of the IP/Brand owner in the title and/or description of the products in the product listings or use copyrighted content, belonging to IP/Brand owner, in the form of product images, video and/or text.

In one scenario, it may be possible that some of these third parties may inadvertently, or even willfully, create one or more product listings under a brand name, for example, in an attempt to sell counterfeit versions of the product as the one from the product listing even if the product listing has not obtained prior authorization to do so in any manner or form by the licensor, for instance, the manufacturer, or an other entity representative of stakeholdership in the commercial interest from the product such as, but not limited to, an inventor, an investor, or any other person or entity. As used herein, a scope of the term ‘person’ or ‘entity’ is to be construed as being used without limitation thereto.

In another scenario, it may be possible that in order to create these licensed/unlicensed product listings, a third party, or the content creators, associated with, for example, as vendors of content creation to the third party, may inadvertently, or even willfully, create these product listings with the brand name in the title, even though the actual items may not be manufactured by the brand.

In yet another scenario, it may be possible that these third parties, or content creators, may create product listings under a brand name to sell products that are parallel imports, as this could be in violation of, amongst other things, terrestrial or other laws of the respective jurisdiction.

In yet another scenario, it may be possible that these third parties, or content creators, may create product listings using the images or video that has been copyrighted by the IP/brand owner and in some cases, these third parties, or content creators may have done so without the explicit consent of the IP/brand owner (or the licensor).

In yet another scenario, it may be possible that these third parties, or content creators, may inadvertently, or willfully, create web domains/sites containing the trademarked brand name of an entity, for example a first entity, with a product made by another entity, for example, a second entity.

In yet another scenario, it may be possible that these third parties, or content creators, may create fake product listings or advertisements, where there is no actual product to ship for, under a brand name. These content creators may create these fake product listings or advertisements in order to defraud consumers, for instance, by receiving money while there is no product to ship for, or in exchange of, the received money resulting in, for example, one or more types of cyber-related crimes being committed by such third parties and/or content creators.

In yet another scenario, it may be possible that these third parties, or content creators, may create fake/imposter product listings or advertisements, for example, using fake/impostor accounts on social media channels, web domains/sites, or other social channels in order to defraud consumers. These types of third parties, or content creators, may be swift in uploading and subsequently deleting such fake/impostor accounts vis-a-vis the fake/impostor product listings or advertisements contained therein that may negatively impair brand image and/or customer perception of the product.

Therefore, in the case of suspected trademark infringement, counterfeit or non-licensed products, known, or existing, solutions are less than helpful in enabling IP/Brand owners to attempt in verifying the identity of these third parties, or content creators, or authenticating the products listed by these third parties or content creators. The current i.e., known, or existing, solutions may at best, allow the IP/Brand owner to merely find these product listings related to their IP online and the IP/Brand owner is left with no option but to, at best, manually initiate action by taking down the discovered product listings created by these third parties or content creators. This approach would also entail judgement calls to be made on the part of the IP/Brand owner for acting against such third parties, or content creators, who have been discovered on one or more aspects including, but not limited to, whether the listed item is genuine or not. Also, owing to the very high volume of product listing, or content, this approach would also be ensued by the potential of the IP/Brand owner either missing out on a lot of IP infringing product listings, or content, or inadvertently removing, for example, a lot of product listings, or content, erroneously.

### SUMMARY

To overcome the above-mentioned limitations and problems, the present disclosure provides a system and a method for verifying, authenticating and tagging of anonymous online content creators.

In an aspect of the present disclosure, the system for verifying, authenticating and tagging of anonymous online content creators includes a processor and an output device having a Graphical User Interface (GUI) in communication with the processor. The processor is configured to operably render the GUI for displaying one or more user-selectable options for requesting a user of the GUI to input data pertaining to Intellectual Property (IP) and pre-defined user criteria, fetching one or more product listings related to the IP and satisfying the pre-defined user criteria input by the user, tagging of one or more content creators related to the one or more product listings, grouping the one or more content creators based on various behavioral patterns and attributes associated with each of the one or more content creators, verifying and authenticating if the one or more content creators are in violation of the IP, mapping the one or more content creators into respective ones of a plurality benchmarks based on the verification and authentication, and setting of periodical authentication at a pre-determined frequency based on the map.

In another aspect of the present disclosure, a computer-implemented method for verifying, authenticating and tagging of anonymous online content creators is provided. The computer-implemented method includes the steps of displaying, using a Graphical User Interface (GUI), one or more user-selectable options for requesting a user of the GUI to input data pertaining to Intellectual Property (IP) and pre-defined user criteria. The computer-implemented method further includes fetching, by a processor communicatively coupled to the GUI, one or more product listings related to the IP and satisfying the pre-defined user criteria input by the user. Further, the computer-implemented method also includes tagging of one or more content creators related to the one or more product listings by the processor. Furthermore, the computer-implemented method also includes grouping, by the processor, the one or more content creators based on various behavioral patterns and attributes associated with each of the one or more content creators. Still further, the computer-implemented method also includes verifying and authenticating, by the processor, if the one or more content creators are in violation of the IP. Additionally, the computer-implemented method also includes mapping, by the processor, the one or more content creators into respective ones of a plurality of benchmarks based on the verification and authentication. Still additionally, the computer-implemented method also includes setting, by the processor, a periodical authentication at a pre-determined frequency based on the map.

According to another aspect of the present disclosure, a non-transitory computer readable medium is provided. The non-transitory computer readable medium has stored thereon computer-executable instructions which, when executed by a computer, cause the computer to display one or more user-selectable options requesting a user of the GUI to input data pertaining to Intellectual Property (IP) and pre-defined user criteria, fetch one or more product listings related to the IP and satisfying the pre-defined user criteria input by the user, tag one or more content creators related to the one or more product listings, group the one or more content creators based on various behavioral patterns and attributes associated with each of the one or more content creators, verify and authenticate if the one or more content creators are in violation of the IP, map the one or more content creators into respective ones of a plurality benchmarks based on the verification and authentication, and set a periodical authentication at a pre-determined frequency based on the map.

For purposes of this disclosure, it should be noted that, while, with the use of contracts and/or other agreements, IP/Brand owners can authorize official retail partners, regional distributors, or even media and advertising agencies to create product listings, or content for sales and marketing purposes, in relation to the products that have IP assigned in the name of the IP/Brand owners, these IP/Brand owners may, additionally, or optionally, also license IP associated with these products partly, or in whole, to one or more third parties, or content creators for allowing such licensed third parties, or the content creators associated therewith, to create a wide range of the actual product itself and/or content that is pertinent to the actual product, for example, in the form of merchandise, or services including, but not limited to, advertisements of the product or the like. These contracts and/or agreements are known to typically outline not only the terms and conditions for such product listings but also authorize the specific third parties, or content creators, and their respective channels, associates, or partners that can create such product listings, or content, for the product. With implementation and use of the embodiments disclosed herein, the IP/Brand owner can be facilitated in tracking authorized and unauthorized use of their IP on each channel, or for each third party, and the like.

Various embodiments of the present disclosure provide a tracking system that enables IP/Brand owners, to identify users of their IP, check the channels that these users (of the IP proprietary to the IP/Brand owner) have created the content on, and immediately understand if they have been authorized by the IP/Brand owner to do so, for instance, create the product listing, or content, pertaining to the product on that particular channel.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates a hardware implementation of a system for verifying, authenticating and tagging of anonymous online content creators, in accordance with an embodiment of the present disclosure;

FIG. 2 illustrates a Graphical User Interface (GUI) of the system displaying various types of third party information based on a user request pertaining to data related to Intellectual Property (IP) and pre-defined user criteria, in accordance with an embodiment of the present disclosure;

FIG. 3A illustrates exemplary options available to the user of the GUI or an IP/Brand owner, in accordance with an embodiment of the present disclosure;

FIG. 3B illustrates an exemplary tabulation showing programmatic interactions made by the system for whitelisting or greylisting one or more content creators, in accordance with an embodiment of the present disclosure;

FIG. 4 illustrates exemplary discovered content creators that are assigned the ‘Greylist’ tag as default by the system, in accordance with an exemplary embodiment of the present disclosure;

FIG. 5 illustrates exemplary IP/Brand owners subsequently, and manually, assigning various ‘Whitelist’ options with, and without, applying a grouping algorithm on the discovered content creators;

FIG. 6 illustrates an exemplary electronic communication to the content creator, outlining the reason for the communication and advising that we wish to verify their right to create the content related to the IP owner;

FIG. 7 illustrates an exemplary verification form to the content creator for providing the IP/Brand owner with evidence required to confirm whether the content creator has the requisite permission to list the product, or content;

FIG. 8 illustrates exemplary responses received via the verification forms and logged by the system for further processing and display on the GUI for review by the IP/Brand Owner;

FIG. 9 illustrates exemplary final options available to the IP/Brand owner upon reviewing of verification form data provided by the content creator, in accordance with an embodiment of the present disclosure;

FIG. 10 illustrates exemplary details of the number of enforcements completed and Removed Listings Value data visible to the IP Owner via a dashboard on the GUI, in accordance with an embodiment of the present disclosure.

FIG. 11 illustrates a method for verifying, authenticating and tagging of anonymous online content creators, in accordance with an embodiment of the present disclosure.

FIG. 12 illustrates an exemplary low-level implementation pursuant to the steps of the method from FIG. 11 for realizing functional aspects of the system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

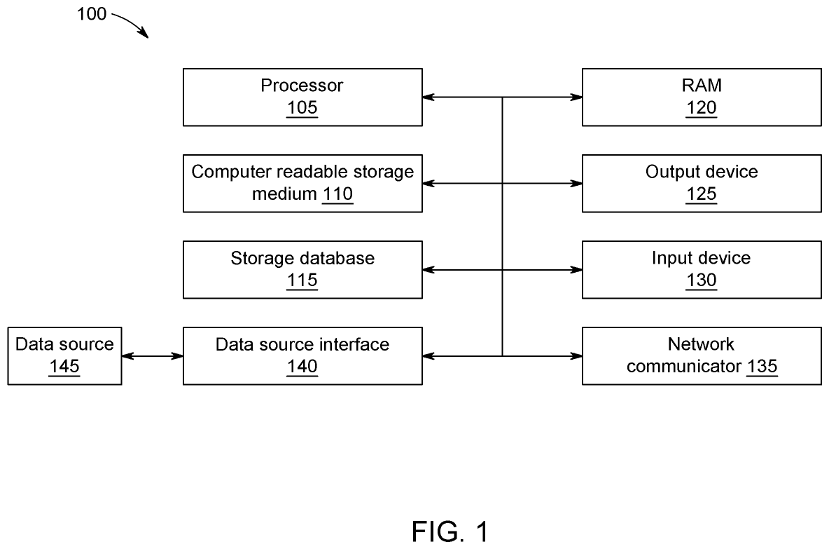

FIG. 1 illustrates a hardware platform 100, in accordance with an embodiment of the present disclosure. The hardware platform 100 may be a computer based system, denoted using identical reference numeral ‘100’, that may be used with the examples described herein and for purposes of realizing embodiments of the present disclosure. The hardware platform system 100 may represent a computational platform that includes components that may be in a server or another computer system. The hardware platform 100 may be hereinafter also referred to as computer system 100, and may execute, by way of a processor (e.g., a single or multiple processors) or other hardware processing circuit, the methods, functions and other processes described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 100 may include a processor 105 that executes software instructions or code stored on a non-transitory computer-readable storage medium 110 to perform methods of the present disclosure. The software code includes, for example, instructions to display one or more user-selectable options for requesting a user of the GUI to input data pertaining to Intellectual Property (IP) and pre-defined user criteria, fetch one or more product listings related to the IP and satisfying the pre-defined user criteria input by the user, tag one or more content creators related to the one or more product listings, group the one or more content creators based on various behavioral patterns and attributes, verify and authenticate if these one or more content creators are in violation of the IP, map these one or more content creators into respective ones of a plurality benchmarks based on the verification and authentication; and set a periodical authentication at a pre-determined frequency based on the map. In an example, the processor 105 may use these software codes that may reside on the computer-readable storage medium 110.

The instructions on the computer-readable storage medium 110 are also read and stored with the instructions in a storage database 115 or with the instructions in a random access memory (RAM) 120 of the computer system 100. The storage database 115 provides a large space for keeping static data where at least some instructions could be stored for later execution. The stored instructions may be further compiled to generate other representations of the instructions and dynamically stored in the RAM 120. The processor 105 may read instructions from the RAM 120 and perform actions as instructed.

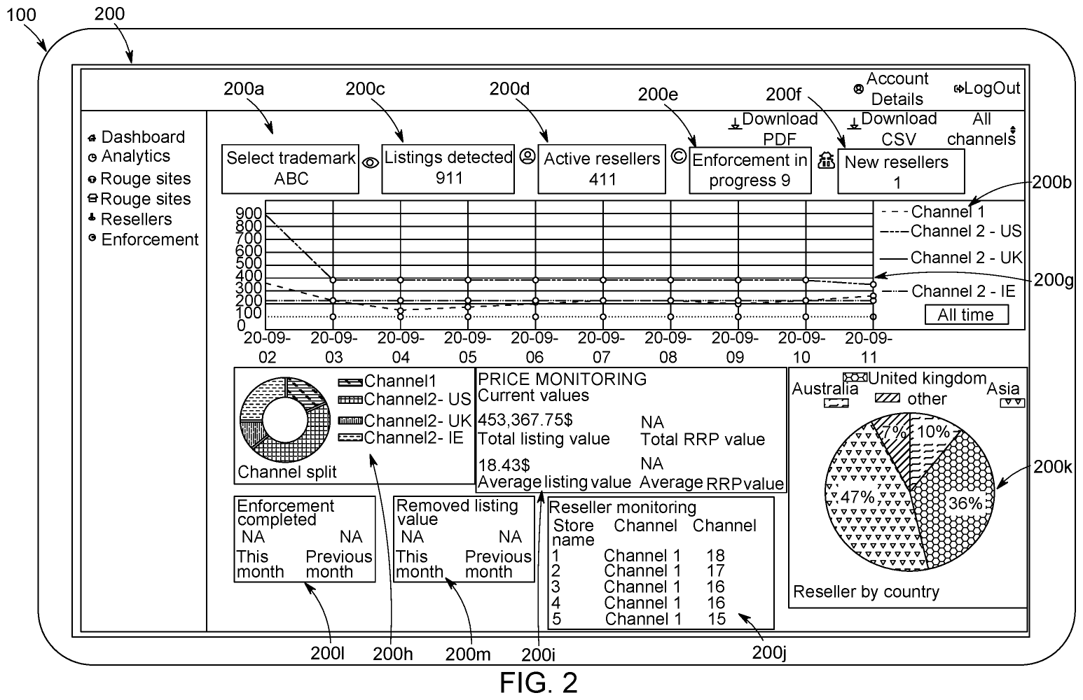

The computer system 100 (hereinafter simply referred to as ‘the system’ and denoted using identical numeral ‘100’) further includes an output device 125 to provide at least some of the results of the execution as output including, but not limited to, visual information to a user, for example, an intellectual property owner, or a product brand owner (hereinafter simply referred to as ‘the IP/Brand owner’). The output device 125 may display the visual information to the user by rendering the visual information on a GUI 200 (shown in FIG. 2) that forms part of the output device 125. The output device 125 can include a display on general purpose computing devices such as, but not limited to, a mobile phone or a laptop, or on specific-types of computing devices such as, but not limited to, virtual reality glasses. The GUI 200 and text, images, and/or video contained therein may be presented as an output on the display of the output device 125. The system 100 further includes an input device 130 to provide a user, or another device, with mechanisms for providing data and/or otherwise interacting with the system 100. The input device 130 may include, for example, a keyboard, a keypad, a mouse, or a touchscreen. Each of these output devices 125 and input devices 130 could be joined, for purposes of communication, by one or more additional wired, or wireless, peripherals and/or communication linkages. In an example, the output device 125 may be used to display the GUI 200 as depicted in the view of FIG. 2.

A network communicator 135 may be provided to connect the system 100 to a network, for example, a network and also to other devices connected to the network including clients, servers, data stores, and interfaces, for instance. The network communicator 135 may include, for example, a network adapter such as a LAN adapter or a wireless adapter. The system 100 also may also include a data source interface 140 to access a data source 145. The data source may be implemented by way of an information resource. As an example, a database of exceptions and rules may be a data source. Moreover, knowledge repositories and curated data may be other examples of data sources.

In the present disclosure, various functions, steps, or methods for realizing embodiments of the present disclosure may be performed by one or more components of the system 100. However, for sake of simplicity and clarity of understanding the present disclosure, explanation to the various functions, steps, or methods will be explained in conjunction with the system 100 and such explanation should be construed as being made in a broad sense and will in no way be regarded as being limiting of the present disclosure except where the scope of the present disclosure is as defined by appended claims.

FIG. 2 illustrates the system 100 showing the graphical user interface (GUI) 200 that is configured for displaying a) a region Specific IP Identifier (Trademark, Patent, Copyright etc.) as denoted by reference numeral 200a, b) a list of monitored channels 200b, for example, an online channel 1 such as a first website and an online channel 2 such as a second website that caters to a specific demographic population, for instance, United States of America (USA), United Kingdom (UK), and Ireland (IE) as shown in the view of FIG. 2. The GUI 200 is also configured for displaying a number of listings detected as denoted by reference numeral 200c, number of active content creators detected as denoted by reference numeral 200d, number of enforcements in progress as denoted by reference numeral 200e, number of new content creators detected as denoted by reference numeral 200f, line graph showing historical data related to number of active content creators per channel as denoted by reference numeral 200g, graph showing percentage activity per channel as denoted by reference numeral 200h, price monitoring module showing total value and average value compared against predefined values inputted from the user as denoted by reference numeral 200i, content creator monitoring module, displaying a predefined number of, for instance, the top five content creators, the number of listings created and the channel they are listed on as denoted by reference numeral 200j, pie chart displaying the percentage of content creators by country as denoted by reference numeral 200k, a module showing the number of enforcements for a defined period as denoted by reference numeral 200l, and a module showing the value of content removed through enforcement as denoted by reference numeral 200m.

In embodiments herein, the processor 105 would be configured, upon request by the user, or the IP/Brand owner, to use a programmatic combination of API and website scraping techniques for scanning across web-based, or online, channels including, but not limited to, search engines, websites, marketplaces, social media channels, and web domains including web forums, e-commerce websites and the like to identify intellectual property infringements and policy violations related to a specified rights of an IP holder or the licensor, i.e., the IP/Brand owner.

In an example, these intellectual property infringements and policy violations may include copyright infringement that includes, for example, unauthorized use of copyrighted images, unauthorized distribution of copyrighted software, firmware, or other copyrighted material assigned to, or owned by, the IP/Brand owner (or the licensor).

In another example, the intellectual property infringements and policy violations may include one or more patent infringement in which products that are listed and/or sold under a brand name may be infringing one or more utility patents, the rights of which have been assigned to, or reside with, the IP/Brand owner (or the licensor).

In yet another example, the intellectual property infringements and policy violations may include one or more trademark infringements in which at least one trademarked name or logo is being used to list and/or sell products that are not made by the IP/Brand owner, or stated differently, in selling counterfeited products by, illegally, using the trademarked name or logo whose rights, interests, and title are assigned to, or reside with, the IP/Brand owner (or the licensor).

In yet another example, the intellectual property infringements and policy violations may include one or more design infringements in which products that are listed and/or sold under a brand name may be infringing one or more design patents, the rights of which have been assigned to, or reside with, the IP/Brand owner (or the licensor).

In yet another example, these intellectual property infringements and policy violations may include a combination having two or more from the categorically classified patent infringements, trademark infringements, copyright infringements, and design infringements as well. Accordingly, in this disclosure, the terms “intellectual property infringements” when used in conjunction with, or exclusive of, the terms “policy violations” is to be construed broadly as a scope of each of these terms, when used alone, or in conjunction with each other, may extend to any type of IP infringement or violation known to persons skilled in the art without limitation thereto.

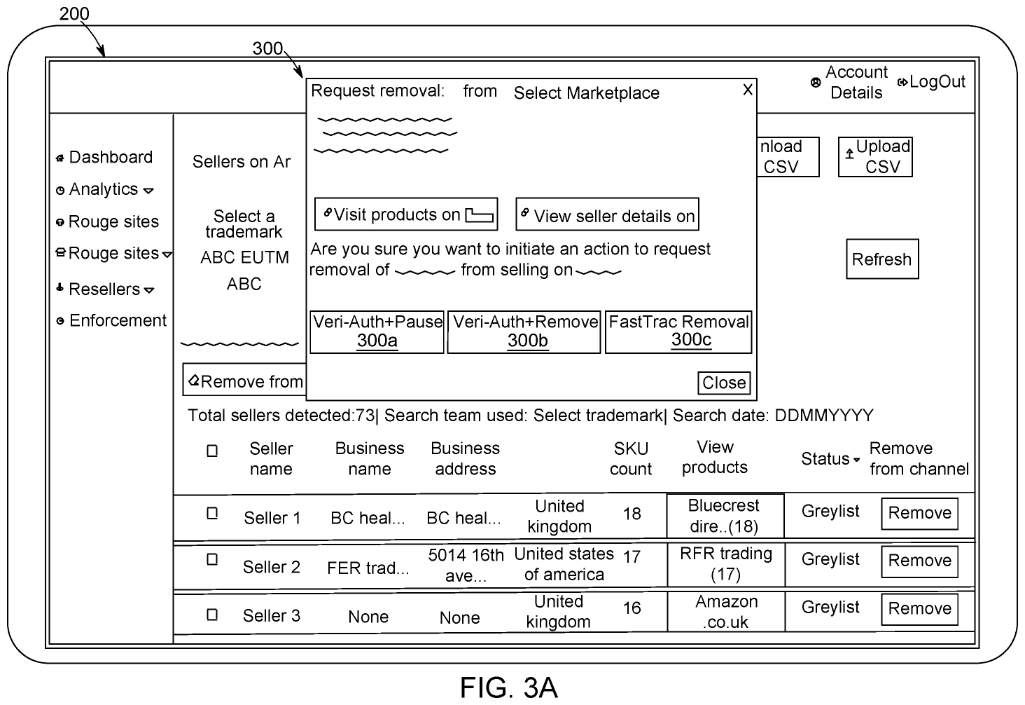

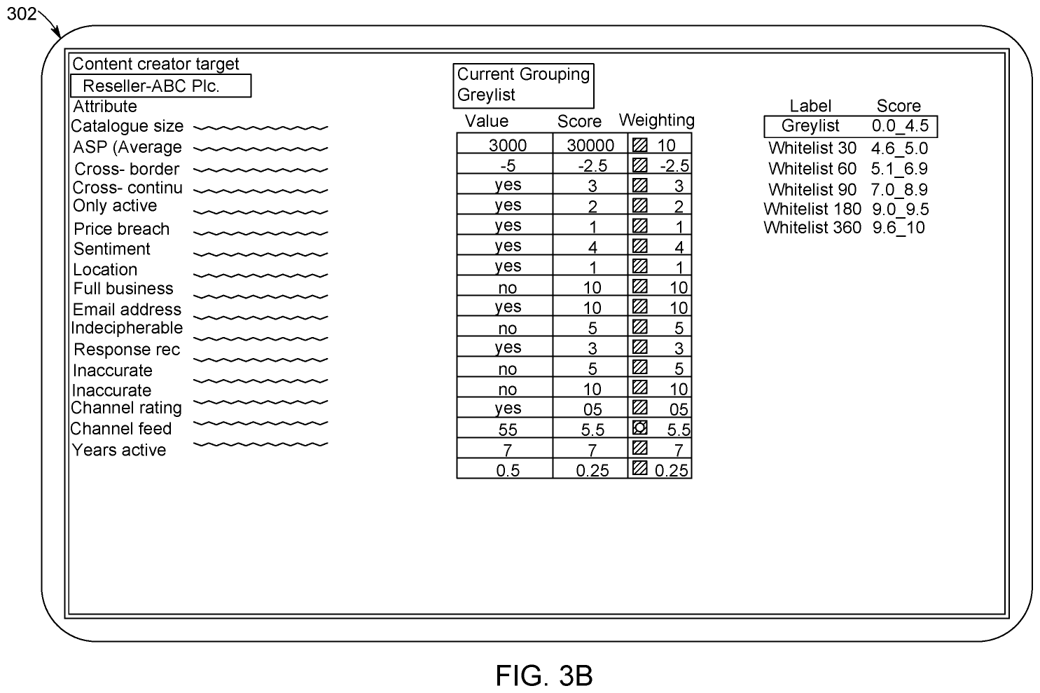

FIG. 3A illustrates a plurality of options 300 provided by the GUI 200 to a user, (for instance, to the IP/Brand owner). As shown, these options may include, a) initiating the verification, authentication process and pause as denoted by reference numeral 300a, b) initiating the verification, authentication process and proceed with enforcement/take-down procedure as denoted by reference numeral 300b, or c) initiating an immediate enforcement/take-down procedure as denoted by reference numeral 300c.

The GUI 200 enables the IP owner/user to be able to review all data displayed and decide on actions to be taken based on the information provided and initiate these actions by manually clicking on a list of actions/options 300 available within the GUI 200. In addition, the GUI 200 may allow the IP/Brand owner/user to set up other rules that are customized to the IP/Brand owner to initiate certain actions when defined parameters are met. Based on these rules set by the IP owner/user and assisted by machine learning and AI algorithms, the system 100 triggers a sequence of actions including auto notifications, verification, evidence logging and removal of infringing content, where appropriate. These rules may help the system 100 to automatically trigger the verification and authentication process when a criteria pertaining to the rule, or set of rules, is met. Some examples of these rules may include: a) if the content creator is based in a user specified jurisdiction, for instance, Asia and the content creator has created the product listing to be on a channel in another user specified jurisdiction, for instance, the United Kingdom, b) if the content creator has created a product listing for a product and the listed price for the product is below a pre-defined threshold, or drops below a predefined percentage threshold, for example, relative to the user-defined Minimum Advertised Price (MAP) or a user-defined Recommended Retail Price (RRP), c) if a feedback score or trust rating for a user selected content creator is below a pre-defined threshold, and/or d) if the content creator has recently joined the channel monitored by the IP/Brand owner, or user of the GUI 200, or if the content creator has created a product listing, or content related to the product manufactured by the IP/Brand owner for the first time.

The system 100 of the present disclosure is configured to categorically classify the content creators detect on the monitored channels, into various groups/categories based on certain behavioral attributes. These behavioral attributes may include, but is not limited to, unusual, atypical or abnormal patterns of creating, or uploading, product listings at non-standard listing hours, unusual, atypical or abnormal patterns of price alteration in the product listing, unusual, atypical or abnormal patterns of fluctuating price in relation to the MAP, or the RRP, each of which are typically defined, or dictated, by the user i.e., the IP/Brand owner, a sentiment analysis obtained from one or more reviews pertaining to the user-selected content creator, non-availability of contact details for a user-selected content creator, non-availability of physical address and business details for a user-selected content creator, and known, or historical, infringement activity that has been previously associated with the content creator. The system 100 of the present disclosure benchmarks such behaviours and patterns of each content creator upon comparison against acceptable parameters of the IP/Brand owner's policies.

In embodiments herein, it is contemplated that an onboarding process is followed to initiate, or induct, the user, or the IP/Brand owner, into the GUI 200 and the system 100 of the present disclosure. During this onboarding procedure, the GUI 200 would also be configured by the system 100 to enable the users, or the IP/Brand owners, to assign a weight to each of the discovered, or specific user-selected, content creators based on, amongst other things, a list of behavioral patterns and attributes of the content creators. The GUI 200 also enables the IP/Brand owners, or the users to set criteria having a minimum threshold for each of the behavioral patterns and attributes of the content creators failing which the GUI 200 would be configured to display the options 300a-300c, as shown in the view of FIG. 3A, to the IP/Brand owners, or to the users of the GUI 200, for taking the actions based on, for instance, a type and/or number of criteria that has been unmet by, or has been failed in duly complying with on the part of, the content creator that has been discovered for the specific product listing.

Also, in the onboarding process, and prior to discovery and/or selection of the content creators by the user, or the IP/Brand owner, the GUI 200 also facilitates the user, or the IP/Brand owner, to not only select the regions i.e., jurisdictions and/or channels that the user, or the IP/Brand owner wish to monitor but also facilitates the user, or the IP/Brand owner to provide the relevant IP, for example, one or more of trademark/s, patent/s, or copyright/s that will be used to scan the user-selected regions and channels for content creators that may be potentially infringing the IP owned by, or assigned to, the IP/Brand owner. During this process, the GUI 200, will also be configured to display the various attributes that the system 100 has used to discover and assess each of the content creators upon scanning the user-selected regions and channels. Based on the attributes used by the system and displayed on the GUI 200 to the IP/Brand owner, or the user of the GUI 200, the system 100 can then decide which of these attributes are most important based, inter alia, on their desired IP strategy, distribution model etc. and assign a score/weight to each of these attributes displayed on the GUI 200. In an alternative mode of operation, the system 100 may be configured to allow the user of the GUI 200, or the IP/Brand owner to select default, or pre-set, weights for each of the attributes. Alternatively, the system 100 may allow the user of the GUI 200, or the IP/Brand owner to elect, or opt, to ‘switch off’ the option for customized weighting system altogether and may further allow the user of the GUI 200, or the IP/Brand owner to initiate actions by manually assigning a label, for example, a ‘Whitelist’ label, or a ‘Greylist’ label to each content creator. The terms ‘Whitelist’ and ‘Greylist’ disclosed herein are terms that are used in a relative sense for denoting a degree of acceptance by the IP/Brand owner, or the user of the GUI 200, pursuant to, or based on, a level of compliance by the content creator to the IP policies of the IP/Brand owner.

For assigning these labels, it is to be noted that the system 100, upon passage of a pre-determined amount of time, for example, 72 hours or more, may collate data pertaining to each of the discovered, or user-selected, content creators and group these discovered, or user-selected, content creators into relevant categories for allowing the user in subsequently applying a whitelisting period collectively for each group of content creators. Once grouped and assigned with labels, the system 100 is nonetheless configured to continue tracking the behavioral patterns of each of these content creators over time to build further historical data pertaining to the behavioral patterns of respective ones of these content creators. These behavioral patterns, as disclosed herein, may, in the case of physical products sold by resellers, include information pertaining to one or more distributors from where the products are being sourced from. Such patterns, for example, the patterns emerging from the resellers stock buying behaviour, may also be used by the system 100 for modifying the previously assigned weight to the content creator of the product listing if, for example, there is the likelihood that the content creator/reseller could be selling, either inadvertently or willingly, counterfeit products in place of the genuine products. As a further example, even if the IP/Brand owner has received proof of purchase from the reseller that gives them confidence that the product is genuine, because it has been purchased from a recognised, or authorized, distributor, this does not give any assurance of the future behaviour of this reseller, as the next time the reseller purchases stock, the stock could likely be from a different distributor/wholesaler, perhaps even from some unknown wholesale website selling job-lots or containers of stock, that could contain counterfeit product instead of the genuine product. Also, as many of the online resellers may be involved in drop-shipping, or in sending stock directly, to e-commerce portals such as, but not limited to, Amazon FBA and other third party logistic warehousing facilities for order fulfilment, these online resellers may never get an opportunity to see or handle the merchandise that they purchase, and consequently, these online resellers could easily end up unwittingly selling counterfeit products, or otherwise inferior product in place of the genuine product. Therefore, such behavioral patterns like how often a reseller purchases stock from a different source each time, or every once in a while, can be a key indicator of how likely those reseller's listings are for counterfeit products. However, on the other hand, if the reseller shows a historical behavioral pattern of purchasing, or buying, from a single distributor, this may decrease the likelihood, or the indication, that the products are counterfeit.

Another example of a behavioral pattern that can help identify unauthorized content creators/resellers is when these content creators/resellers create, or upload, product listings during ‘non-standard’ listing hours. For instance, the unauthorized content creators/resellers, in an effort to avoid detection, may willfully activate their product listings, or online content pertaining to the product, outside of standard office hours. This means that the product listings may not be visible on the relevant channels to the IP/Brand owner when the IP/Brand owner is most likely to be monitoring those channels as these product listings may have be activated, for example, after 5 p.m. and deactivated before 7 a.m. during regular business days, or these product listings may be uploaded or remain active online only over the weekends. As such, such practices may be followed even by authorized resellers to correspond with peak buying times for online consumers. The system 100 enables the IP/Brand owner, or the user of the GUI 200, to easily and quickly identify the content creators engaging in such unscrupulous behaviour, and can assign them to a higher risk group of content creators who are more likely to be involved in some form of unauthorized use of the IP assigned to, or owned by, the IP/Brand owners.

In yet other examples, similar patterns to the above may be identified in pricing details, via the product listings, in relation to the MAP or RRP where, in some cases, the prices may statically remain at the MAP or the RRP during office hours while these prices may be dropped well below these thresholds outside of regular office hours. In such cases, the GUI 200 enables the IP/Brand owner, to categorically classify the resellers by moving them into the relevant groups and also increase, or decrease, the whitelisted period. In this disclosure, the terms ‘whitelisting’ or ‘whitelisted period’ are labels that are assigned to each of the resellers/content creators based on the weights that are associated with respective ones of the resellers/content creators.

Accordingly, based on the weight assigned to a particular content creator/reseller, that indicates the likelihood of that content creator being involved in IP infringing activities, the system 100 allocates each content creator/reseller to a risk ‘group’ therein, and each group of content creators/resellers are in turn mapped to a specific whitelist period label. The higher the weight, or the lower the risk score, the lower the whitelisted period. Similarly, in this manner, risk scores for particular content creators/resellers that are below a predefined threshold result in those content creators/resellers being assigned to a ‘Greylist’ group label (as shown in the exemplary tabulation 302 of FIG. 3B), and such content creators/resellers may be moved through the verification and/or authentication process.

With use of the system disclosed herein, the IP/Brand owner can, at least in part, be informed so as to take decisions, or actions, based on behaviours, patterns and attributes for content creators/resellers that are identified by the system 100 as having a higher likelihood of IP infringement and subsequently move, or route, such content creators/resellers through a verification and/or authentication process more frequently, for example, once every few hours as opposed to days, when such content creators/resellers fall into the higher risk groups.

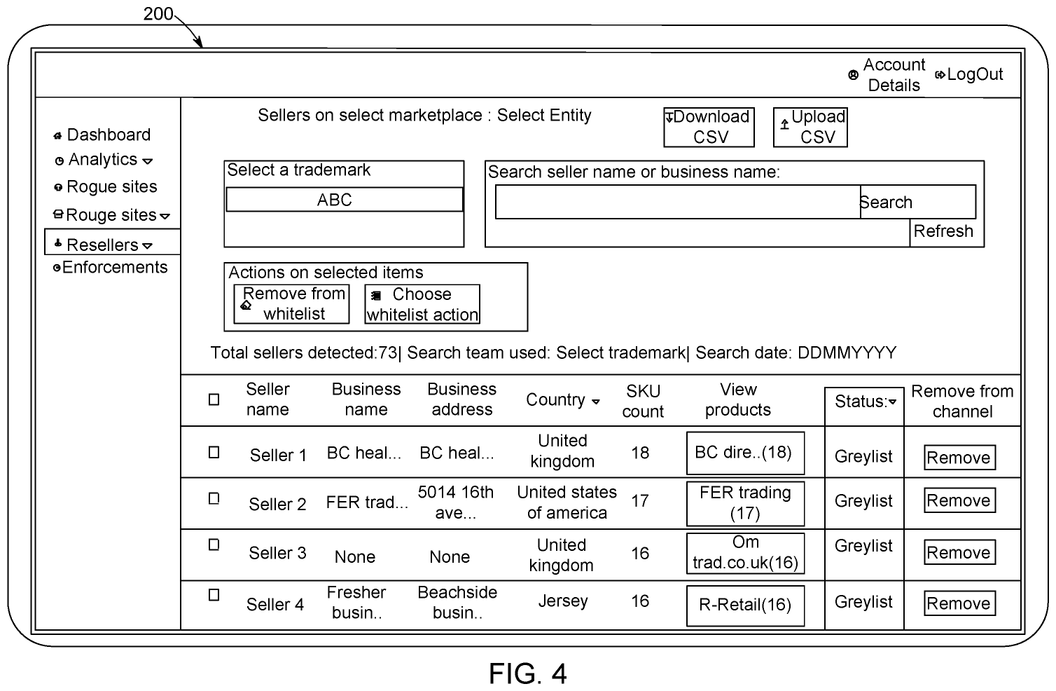

FIG. 4 illustrates the GUI 200 showing all of the discovered content creators/resellers being assigned with a ‘Greylist’ tag as default by the system 100, in accordance with an embodiment of the present disclosure. As a default starting point, all content creators/resellers detected and fetched into the GUI 200 are assigned by the system 100 with a ‘Greylist’ tag as shown in the view of FIG. 4. When content creators/resellers are detected and fetched into the GUI 200 by the system 100, following a request from the IP/Brand owner, or by the user of the GUI 200, the IP/Brand owner can further request the system 100 to monitor specific channels that they wish to monitor. For instance, during the onboarding process, or at any point in time after the onboarding process, the, the system 100 may monitor channel ‘X’, for example, Amazon.co.uk, eBay.de etc. for IP related to product name ‘Y’ using, for example, trademark name ‘Samsung Galaxy’, another trademark logo, or other copyrighted images relating to the product and that are likely to be used by, or found in, the product listings. The system 100 may then execute, for instance by running, a script, for example, by way of a web scraping algorithm that is configured, or programmed, to detect and fetch all the product listings, or content related to the IP for product ‘Y’ on channel ‘X’. Upon fetching these product listings, or content related to the IP for product ‘Y’ on channel ‘X’, such product listings, or content related to the IP for product ‘Y’ on channel ‘X’ will be displayed by the system 100 to the IP owner using the GUI 200. The tagging, or labelling i.e., whitelisting/greylisting of online resellers/content creators, upon detection and fetching of the online resellers/content creators can beneficially help IP/Brand owners, or the user of the GUI 200 to create a repository, or a database, of every reseller's/content creator's product listing their IP and also facilitate the IP/Brand owners, or the user of the GUI 200 to create a wide range of rules based on these tags.

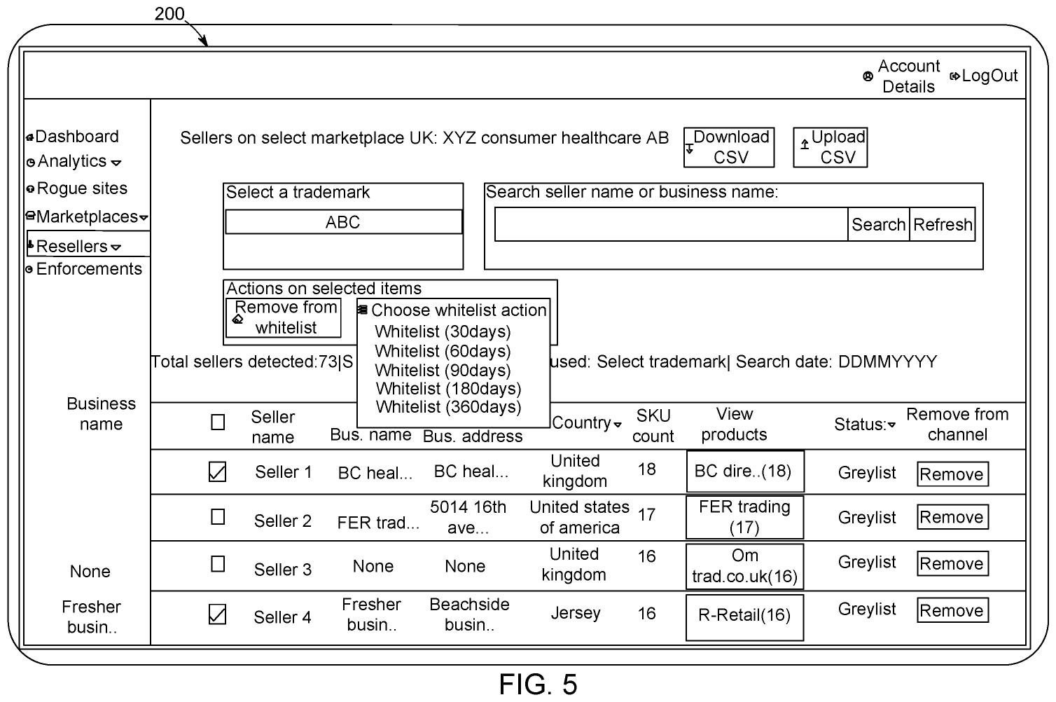

FIG. 5 illustrates the user selectable assignment of various types of ‘Whitelisting’ options either individually, or collectively using the grouping algorithm to automatically assign the appropriate whitelist option to the content creators/resellers. As shown in the view of FIG. 5, the GUI 200 may also enable the IP/Brand owner or the user of the GUI 200 to manually override the assigned ‘Whitelist’ tag or label, which may initiate the verification/authentication process on any content creator/reseller or even fast track the verification/authentication process up to the point of an enforcement against that content creator/reseller.

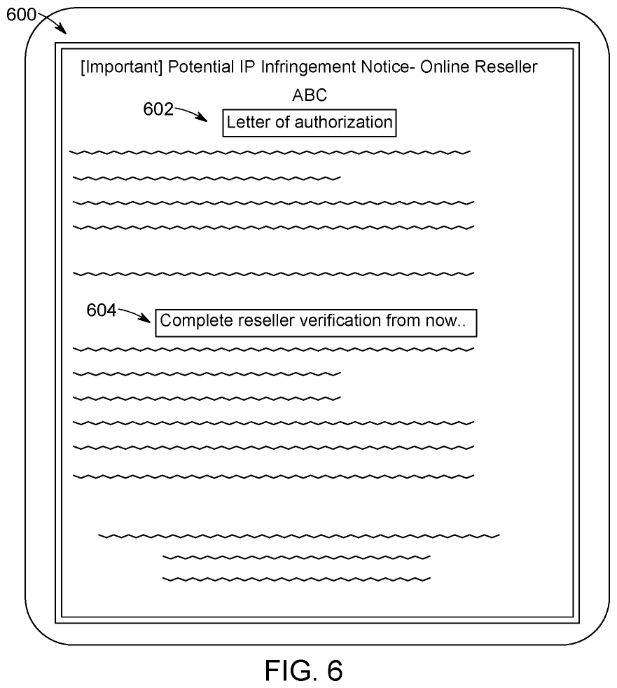

Once the whitelisting period expires, or if the the verification/authentication process is initiated, a notification 600, as exemplarily shown in the view of FIG. 6, may be sent by the system 100 to the email address or the communication portal of the relevant content creators/resellers that are likely in violation of one of more policies of the IP/Brand owner. Reseller Veri-auth—a combined process of simultaneously verifying the online content creators identity and authenticating the valid use of the IP owned by, or assigned by law to, the IP/Brand owner. The script, or algorithm, run by the system uses data pertaining to one or more metrics including, but not limited to, listed price of the product versus RRP or MAP, recent seller feedback, or confidence, score and pertinent sentiment analysis, country of origin and other data disclosed earlier herein to either initiate the veri-auth process or reduce the whitelisted period for ensuring that a maximum number of counterfeit products are detected so that a removal of such product listings and/or the products themselves can be enforced by the IP/Brand owner.

In embodiments herein and in the case of physical products, the system 100 is also configured to provide, via the GUI 200, to the user, options to flexibly schedule pre-defined intervals for periodical authentication for authenticating the content creators, or resellers with a predefined frequency, for instance, at intervals of 2 hours, 2 days, or any other time interval as desired by the user of the GUI 200, or the IP/Brand owner.

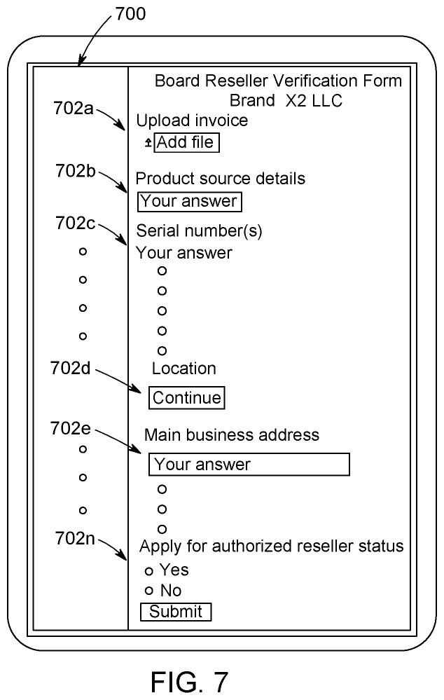

FIG. 6 illustrates an electronic communication, for example, an email to the content creator/reseller, outlining the reason for the communication, preferably within the communication, for example, the e-mail itself, pursuant to the IP/Brand owner's wish to verify if any rights exist with, or have been conferred to, the content creator/reseller to create the product listing, or content related to the product while these rights are in the ownership of, or have been assigned by law to, the IP/Brand owner. This electronic communication forms part of the overall notification 600 triggered by the system 100 as exemplarily shown in the view of FIG. 6. The notification 600 may also contain a link 602 to a letter of authorisation from the IP/Brand owner, if desired by the IP/Brand owner, and also another link 604 to a verification form 700 (as shown in the view of FIG. 7) that must be completed by the content creator/reseller.

FIG. 7 illustrates the verification form 700. On receipt of the notification 600 shown in the view of FIG. 6, the content creator/reseller will be provided the opportunity to complete the verification form 700 to provide the IP/Brand owner with evidence required to confirm that the content creator/reseller has the requisite permission to list the product listing, or content related to the product, in question. This verification form 700 may include one or more fields 702a-n including, but not limited to, ‘Upload Invoice’ as exemplarily denoted by reference numeral 702a for proof of purchase and to identify if the product was sourced from a recognized/authorized distributor, ‘Product Source Details’ as exemplarily denoted by reference numeral 702b, ‘Serial Number(s)’ as exemplarily denoted by reference numeral 702c, ‘Location/Country’ as exemplarily denoted by reference numeral 702d, ‘Business Address’ as exemplarily denoted by reference numeral 702e, and the like. It is hereby contemplated by way of an embodiment herein that a number and type of requests pertaining to each of these fields 702a-n may also be customizable by the IP/Brand owner during the onboarding process.

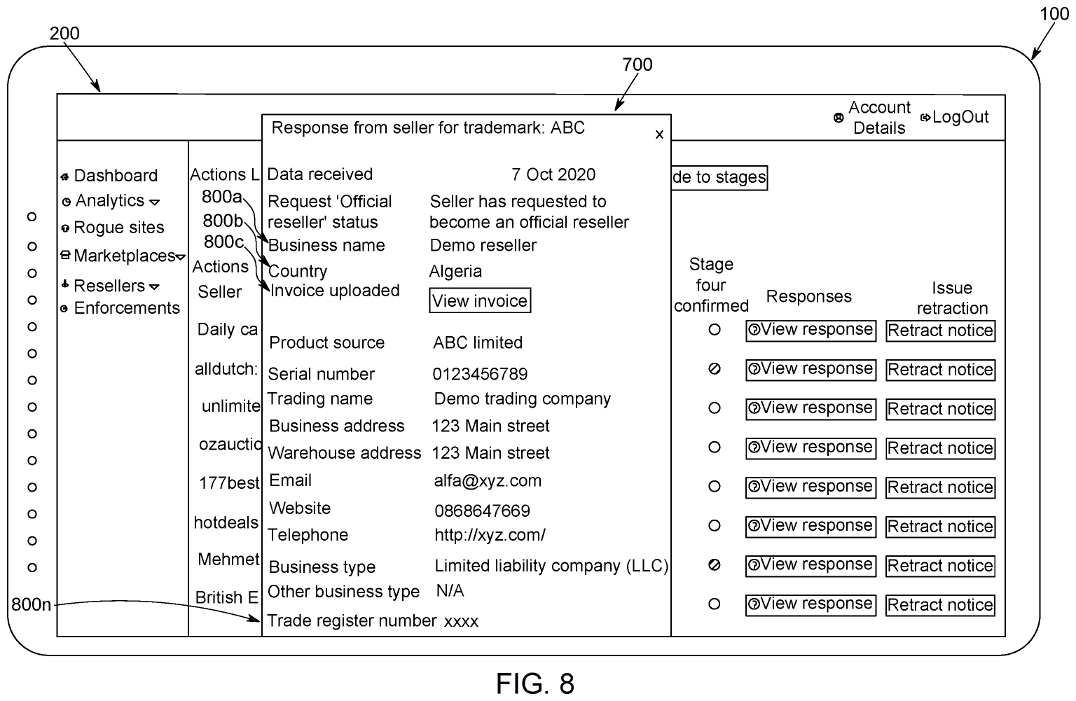

FIG. 8 illustrates responses 800a-n that are received by the IP/Brand owner via the verification form 700. These responses 800a-n are logged in the database 115 (as shown in the view of FIG. 1), processed and displayed on the GUI 200 for review by the IP/Brand owner. The GUI 200 enables the IP/Brand owner to decide on the next action to take with regard to the content creator/reseller upon reviewing the information, or responses 800a-n, provided via the verification form 700. In some embodiments, this decision making process may be completed programmatically, at least in part, by the system 100, for instance, by cross referencing, or by comparing, the received information, or responses 800a-n, provided via the fields 702a-nincluding, but not limited to, the serial number, the lot number, the batch number, the IMEI data etc. against an authenticated data repository that is centrally held, for example, within the database 115 shown in the view of FIG. 1.

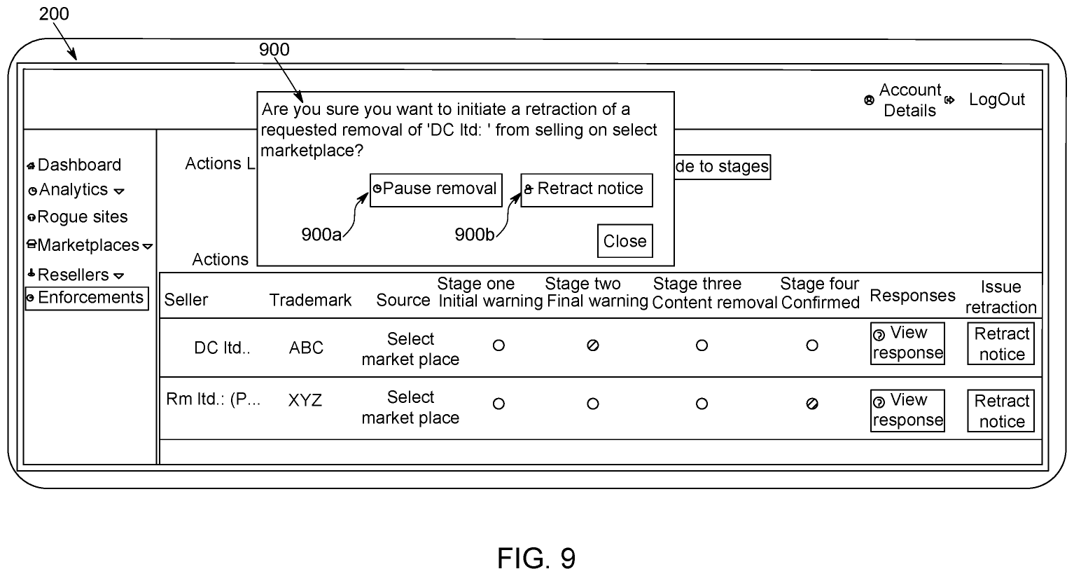

FIG. 9 illustrates a final option form 900 containing one or more final options 900a-n provided by the system 100 to the IP/Brand owner upon reviewing of data, or responses 800a-n provided by the content creator/reseller via the verification form 700 of FIG. 8. These final options 900a-n provided to the IP owner via the GUI 200, at this point in time, may include, but is not limited to, a) proceeding with an enforcement and submission of a takedown request, b) pausing the removal process for the content creator/reseller as exemplarily denoted by reference numeral 900a or c) retracting the notice and enforcement action based on the evidence, or responses 800a-n provided by the content creator/reseller as exemplarily denoted by reference numeral 900b.

It is hereby also contemplated that there may be additional scenarios that may arise following the initiation of the verification/authentication process by the IP/Brand owner. Some of these scenarios and their corresponding path/course of action are exemplarily outlined below:
Scenario/Path 1—Super simple, Content removed—the system 100 sends the notification 600 (refer to FIG. 6) to the content creator/reseller. The system 100 allows the content creator/reseller to provide inputs pertaining to ‘self-select’ out and delist the product listing, or the content related to the product, in question. No further action is needed from the IP/Brand Owner as the system 100 then removes the product listing, or content, from corresponding retail channels. This particular scenario would include the system 100 tagging, and storing details pertaining to, such content creator/reseller and in the event that they relist, the system 100 can issue a high level warning, for example, a stage-2 warning.
Scenario/Path 2—Simple, Content approved—the system 100 sends the notification 600 to the content creator/reseller and evidence, in the form of responses 800a-n, received from the content creator/reseller on the GUI 200 of the system 100. The GUI 200 of the system 100 enables the IP/Brand owner to review the responses, accept the evidence and apply a Whitelist tag to the content creator/reseller for a defined period (as shown exemplarily in the view of FIG. 5).
Scenario/Path 3—Minimal complexity, Content approved—the system 100 sends the notification 600 to the content creator/reseller and evidence, in the form of responses 800a-n, received from the content creator/reseller on the GUI 200 of the system 100. The GUI 200 enables the IP/Brand owner to review the responses and request for further evidence from the content creator/reseller. Upon providing further evidence, the GUI 200 enables the IP/Brand owner to accept the further (additional) evidence and apply a Whitelist tag to the content creator/reseller for a defined period (as shown exemplarily in the view of FIG. 5).
Scenario/Path 4—Medium complexity, Content approved—the system 100 sends the notification 600 to the content creator/reseller and evidence, in the form of responses 800a-n, received from the content creator/reseller on the GUI 200. The GUI 200 enables the IP/Brand owner to review the responses and request for further evidence by moving back and forth, in correspondence with the content creator/reseller, through Scenario/Path 2 process twice. Upon providing further (additional) evidence, the GUI 200 enables the IP/Brand owner to accept the further (additional) evidence and apply a Whitelist tag to the content creator/reseller for a defined period (as shown exemplarily in the view of FIG. 5).
Scenario/Path 5—High complexity, Content approved—the system 100 sends the notification 600 to the content creator/reseller and evidence, in the form of responses 800a-n, received from the content creator/reseller on the GUI 200. The GUI 200 enables the IP/Brand owner to review the responses and request for further evidence by moving back and forth, in correspondence with the content creator/reseller, through Scenario/Path 2 process thrice. Upon providing further (additional) evidence, the the GUI 200 enables the IP/Brand owner to accept the further (additional) evidence and apply a Whitelist tag to the content creator/reseller for a defined period (as shown exemplarily in the view of FIG. 5).
Scenario/Path 6—Minimal complexity, not approved—the system 100 sends the notification 600 to the content creator/reseller and evidence, in the form of responses 800a-n, received from the content creator/reseller on the GUI 200. The GUI 200 enables the IP/Brand owner to review the responses and reject the evidence, for instance, owing to one or more violations on the part of the content creator/reseller as determined by the IP/Brand Owner, and in response, the system 100 proceeds to implement an enforcement/takedown action.
Scenario/Path 7—Medium complexity, not approved—the system 100 sends the notification 600 to the content creator/reseller and evidence, in the form of responses 800a-n, received from the content creator/reseller on the GUI 200. The GUI 200 enables the IP/Brand owner to review the responses and o request for further evidence. Upon providing further (additional) evidence, the GUI 200 enables the user to reject the further (additional) evidence and consequently, the system 100 proceeds to implement an enforcement/takedown action.
Scenario/Path 8—High complexity, not approved—the system 100 sends the notification 600 to the content creator/reseller and evidence, in the form of responses 800a-n, received from the content creator/reseller on the GUI 200. The GUI 200 enables the IP/Brand owner to review the responses request for further evidence by moving back and forth, in correspondence with the content creator/reseller, through Scenario/Path 2 process twice. Upon providing further (additional) evidence, the GUI 200 enables the IP/Brand owner to reject the further (additional) evidence and consequently, the system 100 proceeds to implement an enforcement/takedown action.
Scenario/Path 9—Super Simple, No Response, Listing/Content Takedown—the system 100 sends the notification 700 to the content creator/reseller but no response is received at the GUI 200 i.e., the content creator/reseller does not respond. In this scenario, the system 100 is configured to send a follow-up notification after a pre-determined amount of time, for example, 72 hours and no response is received at the GUI 200 of the system 100 i.e., the content creator/reseller still does not respond. Upon lapse of another pre-determined amount of time, for example, 24 hours after sending the follow-up notification, the system 100 initiates a takedown notice. This content creator/reseller would be tagged by the system 100 in the event that they list new content on the same channel, or even if they appear on other, or additional, channels.
Scenario/Path 10—‘FastTrac’ Content Takedown—In case of repeat offenders or clear irrefutable evidence of infringement, the system 100 bypasses the notification process. Also, in this scenario, the system 100 is configured to initiate an enforcement/takedown process (as exemplarily shown and provided by way of the option 300c in the view of FIG. 3A).

It may be noted that, with implementation of the embodiments disclosed herein, in each of the scenarios/paths 1-10 outlined above, evidence of each stage of correspondence with the content creator/reseller may also be logged, or stored, for instance, in the database 115 for future reference by the system. Once the various paths/scenarios 1-10 outlined above have resulted in a takedown action, the system 100 may also be configured to standardize the infringement submission and takedown process for the relevant channel, and may proceed to submitting these takedown requests either programmatically, or manually upon request by the user of the GUI 200, or the IP/Brand owner to the relevant channel. Additionally, or optionally, in some embodiments, the system 100 may proceed by adding data pertaining to these takedowns into a ticketing system that may subsequently be submitted by an in-house team of the IP/Brand owner to the relevant channel and/or the content creator/reseller.

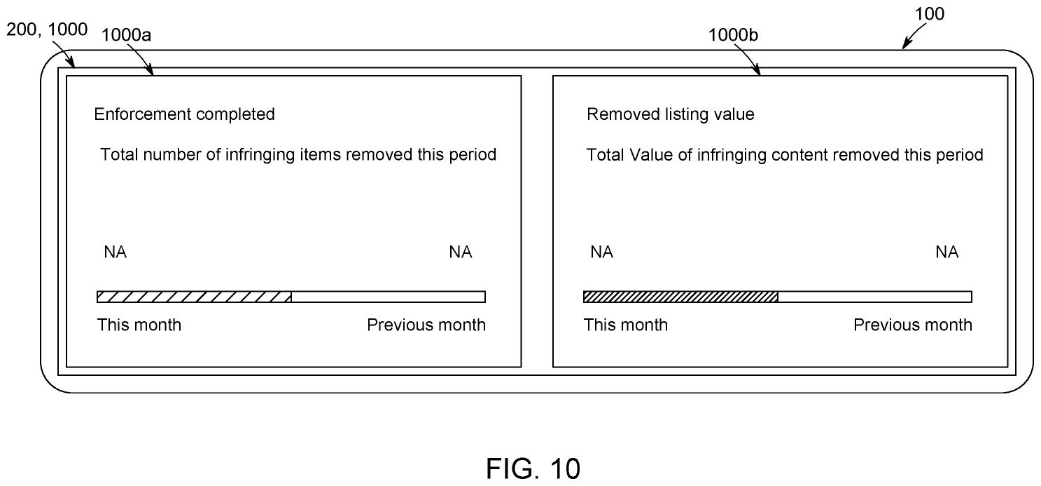

FIG. 10 exemplarily illustrates details including, or pertaining to, a number of enforcements that have been completed, as exemplarily denoted by reference numeral 1000a, together with Removed Listings Value data as exemplarily denoted by reference numeral 1000b, that are displayed on the GUI 200 to the IP/Brand owner via a dashboard 1000 on the GUI 200. Also, details of any monetary value, if, or where, applicable, to the removed listing may also be displayed via a dashboard 1000 on the GUI 200 to the IP/Brand owner. In case, a details of any monetary value are unavailable, then appropriate indication ‘Not Available’ or ‘NA’ may be displayed by the system 100 on the GUI 200 as shown exemplarily in the view of FIG. 10.

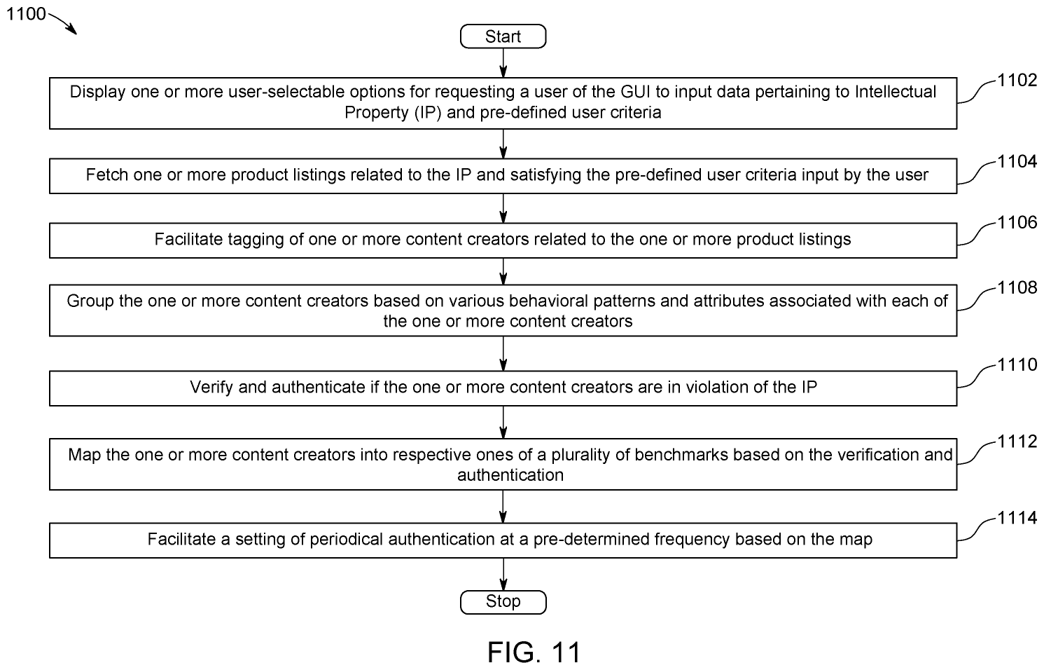

Referring to FIG. 11, a flowchart of a computer-implemented method 1100 for verification, authentication and tagging of anonymous online content creators/resellers is depicted. For sake of brevity and simplicity in this disclosure, the terms ‘computer-implemented method’ will hereinafter be referred to as ‘the method’ and designated using identical reference numeral ‘1100’.

As shown, at step 1102, the method 1100 includes displaying, using the GUI 200, one or more user-selectable options for requesting a user of the GUI 200 to input data pertaining to Intellectual Property (IP) and pre-defined user criteria.

Further, at step 1104, the method 1100 also includes fetching, by the processor 105 communicatively coupled to the GUI 200, one or more product listings related to the IP and satisfying the pre-defined user criteria input by the user.

Also, at step 1106, the method 1100 further includes tagging, by the processor 105, one or more content creators related to the one or more product listings.

Furthermore, at step 1108, the method 1100 also includes grouping, by the processor 105, the one or more content creators based on various behavioral patterns and attributes associated with each of the one or more content creators. Grouping, used herein, can be regarded as the event in which the processor 105 categorically classifies, or buckets, the one or more content creators based on various behavioral patterns and attributes associated with each of the one or more content creators.

Still further, at step 1110, the method 1100 also includes verifying and authenticating, by the processor 105, if the one or more content creators are in violation of the IP.

Additionally, at step 1112, the method 1100 also includes mapping, by the processor 105, the one or more content creators into respective ones of a plurality of benchmarks based on the verification and authentication.

Still additionally, at step 1114, the method 1100 also includes setting, by the processor 105, periodical authentication at a pre-determined frequency based on the map.

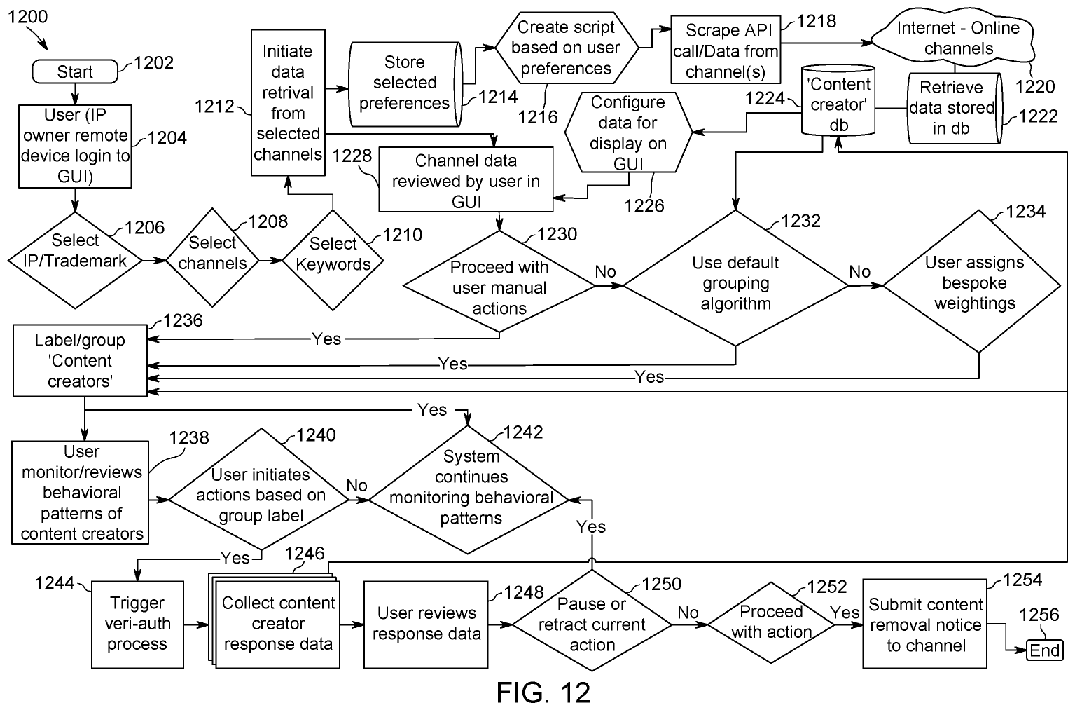

Referring to FIG. 12, a flowchart of a process showing an exemplary low-level implementation 1200 pursuant to the steps 1102-1110 of the method 1100 from FIG. 11 is depicted for realizing functional aspects of the system 100, in accordance with an embodiment of the present disclosure. For sake of brevity, detailed explanation to the flowchart of the process depicting the low-level implementation 1200 has been omitted hereinunder to avoid mere recapitulation of aspects already described in this disclosure. For sake of simplicity, the process of the low-level implementation 1200 will be denoted using identical numeral ‘1200’.

As shown, at step 1202 of the process 1200, the process is initiated and proceeds to step 1204 wherein user, for example, the IP/Brand owner logs in to the GUI 200 of the system 100 using appropriate login credentials.

The process 1200 proceeds to step 1206 wherein the GUI 200 of the system 100 outputs a display to request the user to select a desired IP, or Trademark, from a list of available IP/Trademark in the system 100.

The process 1200 proceeds to step 1208, wherein the GUI 200 of the system 100 outputs a display to request the user to select one or more channels, for example, one or more online channels from a list of available channels in the system 100.

The process 1200 proceeds to step 1210, wherein the GUI 200 of the system 100 outputs a display to request the user to select one or more keywords from a list of keywords in the system 100. The selected keywords could pertain to product names, brand names, or catch-phrases for representing brands, but is not limited thereto.

In response to the received inputs in steps 1206 through 1210 by the GUI 200, the system 100, in step 1212 initiates retrieval of data from the selected channels.

Additionally, or optionally, at step 1214, the system 100 is also configured to store user preferences each time the user performs steps 1206 to 1210. The storing of user preferences may be beneficial to the user in that these stored user preferences can be used by the system 100 when suggesting to the user, if the same criteria is to be selected by the user, in subsequent logins. Further, in step 1216, the system 100 may additionally, or optionally, create one or more scripts based on the stored user preferences. Furthermore, in step 1218, the system 100 may scrape Application Program Interface (API) data from the channels by interfacing over a wireless network, for example, the internet.

At step 1222, the system 100 retrieves data stored in a database, for example, a remote server station. Further, at step 1224, the system 100 retrieves data pertaining to a content creator from a content creator's database. At step 1226 of the process 1200, the system 100 configures the retrieved data for display on the GUI 200. At step 1228, process steps 1212 and steps 1226 are merged wherein the system 100 facilitates the user of the GUI 200 to review the displayed data subsequent to which, at step 1230 of the process 1200, the system 100 allows the user to proceed with actions that the user wishes, or desires, to proceed with. At this step 1230, if the user manually wishes to label/group the resellers/content creators with specific labels, the process 1200 proceeds from step 1230 to step 1236 wherein the user of the GUI 200 may use the GUI 200 of the system 100 to label/group the resellers/content creators manually.

Alternatively, if the user wishes to apply default system settings, the process 1200 proceeds from step 1230 to step 1232 wherein the system 100 applies default grouping algorithms to group, or classify, the resellers/content creators. However, for the system 100 to use the default algorithm settings to group, or classify, the resellers/content creators at step 1232, the system 100 may, at step 1234, request the user to additionally, or optionally, provide, or assign, weightings to each of the the resellers/content creators upon which the system 1234 may perform the labelling/grouping of the resellers/content creators at step 1236.

Upon grouping/labelling the resellers/content creators at step 1236, the process proceeds to step 1238 wherein the GUI 200 of the system 100 allows the user to review, or monitor, behavioural patterns of the resellers/content creators.

The process 1200 then proceeds from step 1238 to step 1240 wherein the GUI 200 of the system 100 displays actions that can be selected for initiation by the user of the GUI 200 based on the monitored behavioural patterns of the resellers/content creators and/or the labels assigned to the resellers/content creators. Additionally, regardless of whether any action has been initiated by the user or not, the system 100, at step 1242, continues to monitor the behavioural patterns of the resellers/content creators.

Concurrently, the process 1200 proceeds from step 1240 to step 1244 wherein the system 100 triggers the verification and authorization for each reseller/content creator from the resellers/content creators that have been grouped/labelled and are being monitored simultaneously (see step 1242).

Upon triggering the verification and authorization of each of the resellers/content creators, the system 100 receives, or collects, at step 1246, responses from corresponding ones of the resellers/content creators. These responses may include, for example, evidences as disclosed earlier herein.

In response to receiving the response data from individual ones of the labelled resellers/content creators, the system 100 displays the response data via the GUI 200 and at step 1248 facilitates the user, via the GUI 200 to review the response data for each reseller/content creator.

The process 1200 proceeds from step 1248 to step 1250 wherein the system 100 facilitates the user to pause or countermand an action. For example, the reseller may have provided sufficient evidence and no further verification and authorization may be required, and therefore, the system 100 may autonomously whitelist the reseller, or alternatively, provide options via the GUI 200 to the user i.e., the IP/Brand owner to manually whitelist the now authorized and verified reseller based on the received evidence.

If no action has been paused or countermanded in step 1250, the process 100 proceeds to step 1252 wherein the system 100 facilitates the user to continue with the ongoing action, for example, initiating an enforcement, or takedown, of the listing by the unverified/unauthorized resellers in accordance with scenario based logic for the system 100 disclosed earlier herein.

As shown at step 1254, the process 1200 shows the system 100 submitting a notice for content removal (i.e., take down of the listing) made by the unverified/unauthorized resellers. The process 1200 then proceeds from step 1254 to terminate at step 1256.

Modifications to embodiments of the present disclosure described in the foregoing are possible without departing from the scope of the present disclosure as defined by the accompanying claims. Expressions such as “including”, “comprising”, “containing”, “incorporating”, “consisting of”, or “have” that are used herein to describe and claim the present disclosure are intended to be construed in a non-exclusive manner, namely allowing for items, components or elements not explicitly described also to be present. Reference to the singular is also to be construed to relate to the plural.

What is claimed is:

1. A system for verifying, authenticating and tagging of anonymous online content creators, the system comprising:
a processor; and
an output device having a Graphical User Interface (GUI) in communication with the processor, wherein the processor is configured to operably render the GUI for:
displaying one or more user-selectable options for requesting a user of the GUI to input data pertaining to Intellectual Property (IP) and pre-defined user criteria;
fetching one or more product listings related to the IP and satisfying the pre-defined user criteria input;
tagging of one or more content creators related to the one or more product listings;
grouping the one or more content creators based on various behavioral patterns and attributes associated with each of the one or more content creators;
verifying and authenticating if the one or more content creators are in violation of the IP;
mapping the one or more content creators into respective ones of a plurality benchmarks based on the verification and authentication; and
setting of periodical authentication at a pre-determined frequency based on the map.

2. The system of claim 1, wherein the data pertaining to Intellectual Property (IP) includes at least one of Patent, Copyright and Trademark.

3. The system of claim 1, wherein the pre-defined user criteria includes at least one of:
a region specific IP identifier, a list of monitored channels, a number of listings detected, a number of active content creators detected, a number of enforcements in progress, a number of new content creators detected, a line graph showing historical data related to a number of active content creators per channel, a graph showing percentage activity per channel, a price monitoring module showing total value and average value compared against predefined inputted values, a content creator monitoring module, displaying a pre-defined number of content creators, a number of listings created by the pre-defined number of content creators and an associated channel, a pie chart displaying a percentage of content creators by country, a number of enforcements for a defined period, and a value of content removed through enforcement.

4. The system of claim 1, wherein the processor is configured to assign the one or more content creators related to the one or more product listings with a greylist tag by default.

5. The system of claim 4, wherein the processor is configured to request the user, via the GUI, to assign manually, at least one type of whitelist tag from a plurality of whitelist tags to each of the one or more content creators fetched in relation to the one or more product listings.

6. The system of claim 5, wherein the processor is configured to request the user, via the GUI, to assign manually, at least one type of whitelist tag from the plurality of whitelist tags upon grouping the one or more content creators based on various behavioral patterns and attributes associated with each of the one or more content creators.

7. The system of claim 1, wherein the behavioral patterns and attributes include at least one of:
a listing of products at non-standard listing hours, abnormal patterns of price alteration in the product listing, and abnormal patterns of fluctuating price levels in relation to one or more pre-defined monetary values.

8. The system of claim 1, wherein the processor is configured to operably map each content creator from the one or more content creators using a benchmark selected from a plurality of benchmarks based on the behavioral patterns and attributes.

9. The system of claim 1, wherein the processor is configured to operably render the GUI to display actions including at least one of:
initiating the verification, authentication process and pause;
initiating the verification, authentication process and proceed with enforcement/take-down procedure; or
initiating an immediate enforcement/take-down procedure.

10. A method for verifying, authenticating and tagging of anonymous online content creators, the method comprising the steps of:
displaying, using a Graphical User Interface (GUI), one or more user-selectable options for requesting a user of the GUI to input data pertaining to Intellectual Property (IP) and pre-defined user criteria;
fetching, by a processor communicatively coupled to the GUI, one or more product listings related to the IP and satisfying the pre-defined user criteria input;
tagging, by the processor, of one or more content creators related to the one or more product listings;
grouping, by the processor, the one or more content creators based on various behavioral patterns and attributes associated with each of the one or more content creators;
verifying and authenticating, by the processor, if the one or more content creators are in violation of the IP;
mapping, by the processor, the one or more content creators into respective ones of a plurality benchmarks based on the verification and authentication; and
setting, by the processor, of periodical authentication at a pre-determined frequency based on the map.

11. The method of claim 10, wherein the data pertaining to Intellectual Property (IP) includes at least one of Patent, Copyright and Trademark.

12. The method of claim 10, wherein the pre-defined user criteria includes at least one of:
a region specific IP identifier, a list of monitored channels, a number of listings detected, a number of active content creators detected, a number of enforcements in progress, a number of new content creators detected, a line graph showing historical data related to number of active content creators per channel, a graph showing percentage activity per channel, a price monitoring module showing total value and average value compared against predefined values inputted from the user, a content creator monitoring module, displaying the a pre-defined number of content creators, the number of listings created the pre-defined number of content creators and the channel/s they are listed on, a pie chart displaying the percentage of content creators by country, a number of enforcements for a defined period, and a value of content removed through enforcement.

13. The method of claim 10 further comprising assigning, by the processor by default, a greylist tag to the one or more content creators related to the one or more product listings.

14. The method of claim 13 further comprising requesting the user, via the GUI by the processor, to assign manually, at least one type of whitelist tag from a plurality of whitelist tags to each of the one or more content creators fetched in relation to the one or more product listings.

15. The method of claim 14 further comprising requesting the user, via the GUI by the processor, to assign manually, the at least one type of whitelist tag from the plurality of whitelist tags upon grouping the one or more content creators based on various behavioral patterns and attributes associated with each of the one or more content creators.

16. The method of claim 10, wherein the behavioral patterns and attributes include at least one of:
a listing of products at non-standard listing hours, abnormal patterns of price alteration in the product listing, and abnormal patterns of fluctuating price levels in relation to one or more pre-defined monetary values.

17. The method of claim 10 further comprising mapping, operably by the processor, each content creator from the one or more content creators using a benchmark selected from a plurality of benchmarks based on the behavioral patterns and attributes.

18. The method of claim 10 further comprising operably rendering, by the processor, the GUI to display actions including at least one of:
initiating the verification, authentication process and pause;
initiating the verification, authentication process and proceed with enforcement/take-down procedure; or
initiating an immediate enforcement/take-down procedure.

19. A non-transitory computer readable medium having stored thereon computer-executable instructions which, when executed by a computer, cause the computer to:
display one or more user-selectable options for requesting a user of a Graphical User Interface (GUI) to input data pertaining to Intellectual Property (IP) and pre-defined user criteria;
fetch one or more product listings related to the IP and satisfying the pre-defined user criteria input;
tag of one or more content creators related to the one or more product listings;
group the one or more content creators based on various behavioral patterns and attributes associated with each of the one or more content creators;
verify and authenticate if the one or more content creators are in violation of the IP;
map the one or more content creators into respective ones of a plurality benchmarks based on the verification and authentication; and
set a periodical authentication at a pre-determined frequency based on the map.

20. The non-transitory computer readable medium of claim 19, wherein upon execution of the instructions by the computer, the computer is caused to operably render the Graphical User Interface (GUI) to display actions including at least one of:
initiate the verification, authentication process and pause;
initiate the verification, authentication process and proceed with enforcement/take-down procedure; or
initiate an immediate enforcement/take-down procedure.
